(19) United States
(12) Patent Application Publication
(10) Pub. No.: US 2012/0046042 A1
(43) Pub. Date: Feb. 23, 2012

(54) APPARATUS AND METHOD FOR POWER CONTROL IN GEO-TAGGING IN A MOBILE TERMINAL

(75) Inventor: In-Gu SON, Gyeongsangbuk-do (KR)

(73) Assignee: SAMSUNG ELECTRONICS CO., LTD., Gyeonggi-Do (KR)

(21) Appl. No.: 13/198,118

(22) Filed: Aug. 4, 2011

(30) Foreign Application Priority Data
Aug. 18, 2010 (KR) 10-2010-0079702

(51) Int. Cl. H04W 52/02

(52) U.S. Cl. 455/456.1

(57) ABSTRACT

A method for power control in geo-tagging in a mobile terminal includes: searching for whether serving base station information periodically transmitted from a serving base station, which is currently connected with the mobile terminal, exists in a plurality of pieces of pre-stored image metadata when a camera driving is requested; photographing a subject, and simultaneously driving a location information module when serving base station information does not exist as a result of the search; and storing location information acquired through the location information module in metadata of a photographed image, and mapping the serving base station information to the metadata.

### CLAIM OF PRIORITY

This application claims priority under 35 U.S.C. §119 from a patent application entitled “Apparatus and Method for Power Control in Geo-Tagging in Mobile Terminal” filed in the Korean Intellectual Property Office on Aug. 18, 2010, and assigned Serial No. 10-2010-0079702, the contents of which are hereby incorporated by reference in its entirety.

### BACKGROUND OF THE INVENTION

1. Field of the Invention

The present invention relates to a method and apparatus for power control when geo-tagging is performed in a mobile terminal.

2. Description of the Related Art

Recently, with the development of networking technology and digital devices, many people have uploaded and shared photographs taken by using cameras in their blogs or photo sharing sites. In addition, as map information services have been actively provided in recent years, methods of uploading users' photographs in association with maps have spread gradually.

Internet service companies such as Google and Microsoft allow users to input information associated with photographing locations in addition to simply uploading their photographs on the Internet. As these companies are expanding, they are trying to extend their business to new service areas. One of these new areas is the process of inputting location information associated with a piece of media, referred to as geo-tagging.

By utilizing media which has been tagged with location information, users can acquire various information, such as travel information, in advance through photographs taken by other people at real locations while looking at a map. In addition, as leading Internet service companies provide photo services associated with locations, the interest in geo-tagging has increased. When photographs are uploaded on a web album on the Internet, the photographs are automatically arranged in time order, and also information such as the type of camera used in the photographing is recorded. This can be achieved because exchangeable image file format (EXIF) tag information is automatically stored in a photo header file when an image is captured with the camera.

Meanwhile, FIGS. 1A to 1D are views showing an example of a screen associated with the performance of geo-tagging in a conventional mobile terminal.

An image photographed in a geo-tagging method using a camera cooperating with a GPS is obtained in a manner as shown in FIGS. 1A to 1D. First, while a location information module is being driven in order to acquire location information of a photographed image, as shown in FIG. 1A, the user is notified of a waiting time for acquiring location information, i.e. a message such as “Acquiring Location Information,” in the form of an indicator, as shown in FIG. 1B. Next, when the waiting period, during which the location information module is being driven, has passed, and corresponding location information of the photographed image is acquired, the location information is displayed as shown in FIG. 1C, and geo-tagging onto the corresponding image is performed. Then, the acquired location information is stored together in EXIF tag information, which is automatically stored in a header file of the image onto which the geo-tagging is performed, which is informed to the user in the form of an indicator, as shown in FIG. 1D.

As described above, whenever geo-tagging onto a photographed image is performed, it is necessary to drive the location information module cooperating with a GPS in order to acquire corresponding location information of an area in which photographing is performed. In this case, due to a waiting time during which the location information module is being driven in order to acquire location information, power of the mobile terminal is consumed whenever geo-tagging is performed. Thus, there is a need for an improved power control mechanism to extend mobile phone battery life.

### SUMMARY OF THE INVENTION

Accordingly, the present invention in an exemplary aspect provides an apparatus and method for power control in a mobile terminal in such a manner as to store information on a serving base station, to which the mobile terminal is connected in an area where a recording is performed, together with location information acquired through a location information module, to use the location information stored together with the stored base station information when it is determined that serving base station information of an area where media is recorded is the same as the pre-stored base station information, so that it is possible to perform geo-tagging on a recorded media, without driving a location information module.

In accordance with an exemplary aspect of the present invention, there is provided a method for power control in a mobile terminal, the method including: searching for whether serving base station information periodically transmitted from a serving base station in communication with the mobile terminal, exists in a plurality of pre-stored media metadata when a media capture device driving is requested; recording a subject, and simultaneously driving a location information module when the serving base station information does not exist as a result of the searching; and storing location information acquired through the location information module in metadata of a recorded media, and mapping the serving base station information to the metadata.

In accordance with another exemplary aspect of the present invention, there is provided an apparatus for power control in a mobile terminal, the method including: a image input device; a location information module for acquiring current location information; and a controller for searching for whether serving base station information exists in a plurality of pre-stored image metadata when the media capture device is driven, controlling whether to drive the location information module according to a result of the search, and controlling performing of geo-tagging onto recorded media.

### BRIEF DESCRIPTION OF THE DRAWINGS

The above and other exemplary aspects, features and advantages of the present invention will be more apparent from the following detailed description taken in conjunction with the accompanying drawings, in which:

FIGS. 1A to 1D are views showing an example of a screen associated with the performance of geo-tagging in a conventional mobile terminal;

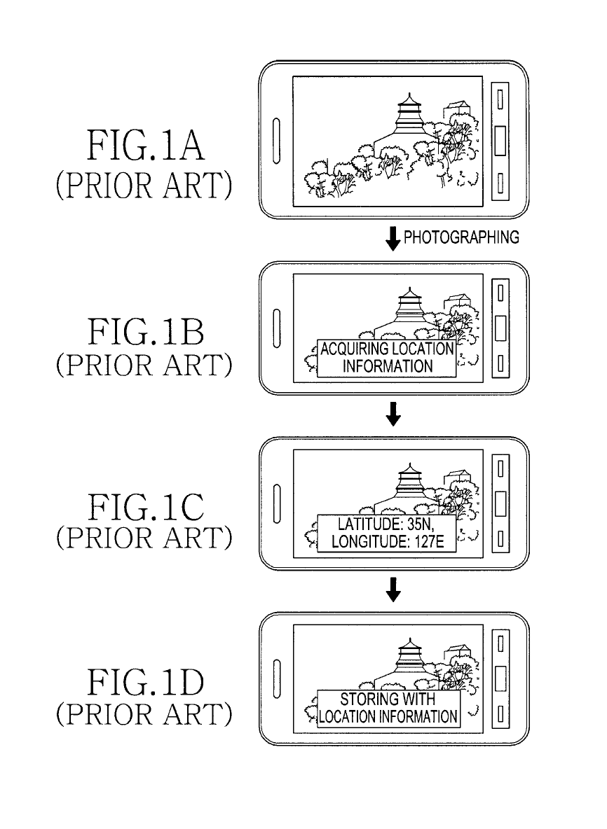

FIGS. 2A and 2B are views showing an example of a screen for explaining a geo-tagging operation for a photographed image in a mobile terminal according to an embodiment of the present invention;

FIG. 3 is a block diagram illustrating the configuration of an apparatus for power control when geo-tagging is performed in a mobile terminal according to an embodiment of the present invention;

FIG. 4 is a view schematically illustrating the configuration of a wireless communication system to which the present invention is applied; and

FIG. 5 is a flowchart illustrating a method for power control when geo-tagging is performed in a mobile terminal according to an embodiment of the present invention.

### DETAILED DESCRIPTION OF THE INVENTION

Hereinafter, exemplary embodiments of the present invention will be described with reference to the accompanying drawings. In the below description, many particular items are shown, but these are provided only to help the general understanding of the present invention. It will be understood by those skilled in the art that various changes in form and detail may be made within the scope of the present invention.

The present invention proposes an apparatus and method for providing geo-tagging for a recorded media in such a manner as to acquire location information of the recorded media through a mobile terminal having a location information module, and simultaneously to store information on a serving base station of the mobile terminal, together with the acquired location information, wherein the serving base station is located in an area in which the image has been recorded. Accordingly, when it is determined that an area where media is recorded corresponds to the area of the same base station as that corresponding to pre-stored base station information, location information stored together with the pre-stored base station information is utilized. Thus, it is unnecessary to drive the location information module to acquire location information whenever geo-tagging is performed, thereby reducing the waiting time for acquiring location information, so that it is possible to reduce the power consumption of the mobile terminal.

Also, preferably, the mobile terminal according to the present invention may be a mobile communication terminal which has a location information module for acquiring location information. In addition, it is apparent that the teachings of the present invention can be applied to other information communication devices, multimedia devices, and their applications, such as a digital broadcasting terminal, a Personal Digital Assistant (PDA), a smart phone, or a 3G terminal. Examples of the 3G terminals are an International Mobile Telecommunication 2000 (IMT-2000) terminal, a Wideband Code Division Multiple Access (WCDMA) terminal, a Global System for Mobile communication (GSM)/General Packet Radio Service (GPRS) terminal, and a Universal Mobile Telecommunication Service (UMTS) terminal.

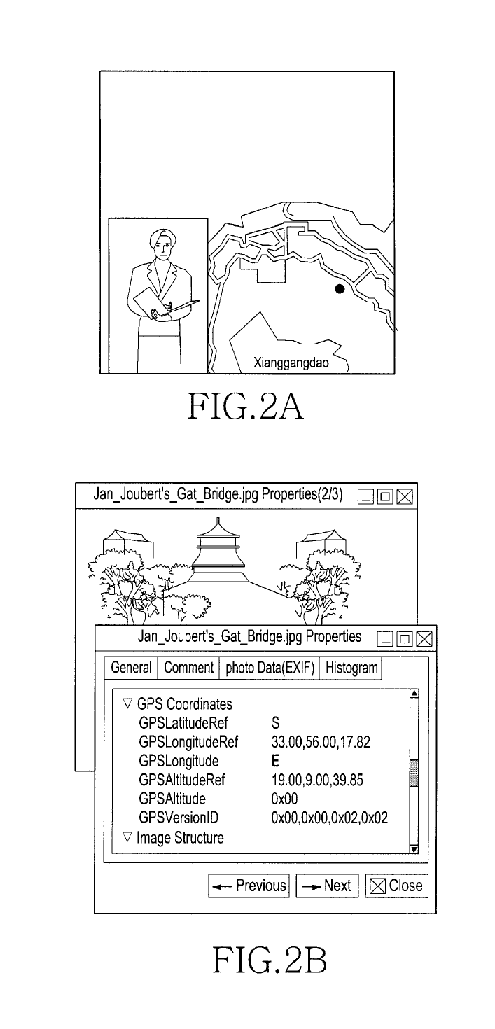

Hereinafter, a geo-tagging operation for a photographed image in a mobile terminal according to an embodiment of the present invention will be schematically described with reference to FIGS. 2A and 2B.

First, FIG. 2A is a view illustrating a map, which includes image data obtained through photographing at a specific location in the form of icons, and image data obtained through real photographing. When the user selects an icon displayed on the map through a user input means, for example, a mouse over or mouse click operation, image data corresponding to the selected icon is displayed on a predetermined position of the map, and location information, i.e. latitude and longitude information, of a location where the photographed image data has been taken is provided together with the image data. The location information associated with the photographed image is obtained through a location information module, e.g. a Global Positioning System (GPS), for identifying or acquiring the position of a mobile terminal. Generally, the location information is provided in such a manner as to calculate accurate time information and distance information from three or more satellites, to calculate latitude, longitude, and time information by applying triangulation to the calculated accurate time and distance information, and to correct errors of the calculated location and time information.

In this case, image data including the location information has been formed in such a manner that specific information of the image data including the location information is automatically stored in an image file in the form of metadata when a photograph is captured by a camera. Here, the metadata means an exchangeable image file format (EXIF) tag, which includes the brand of the camera, a photographing time, exposure information, and a lens focal length. Such attributes of image data, together with a corresponding file name, are provided to the user, as shown in FIG. 2B, so that geo-tagging can be performed on the photographed image.

In this case, according to an exemplary embodiment of the present invention, base server station information is mapped to the location information and is stored in the metadata. Here, the base server station information represents information on a servicing base station which is currently providing a service to the mobile terminal, and includes a downlink center frequency of the base station, an identifier (ID) of the base station, and uplink/downlink channel information. Therefore, in corresponding metadata of an image, including location information, information on a base station managing an area where the image data is photographed, i.e. an area where the mobile terminal is located, is recorded together. The serving base station represents a base station which is connected to the mobile terminal and is currently providing a service to the mobile terminal.

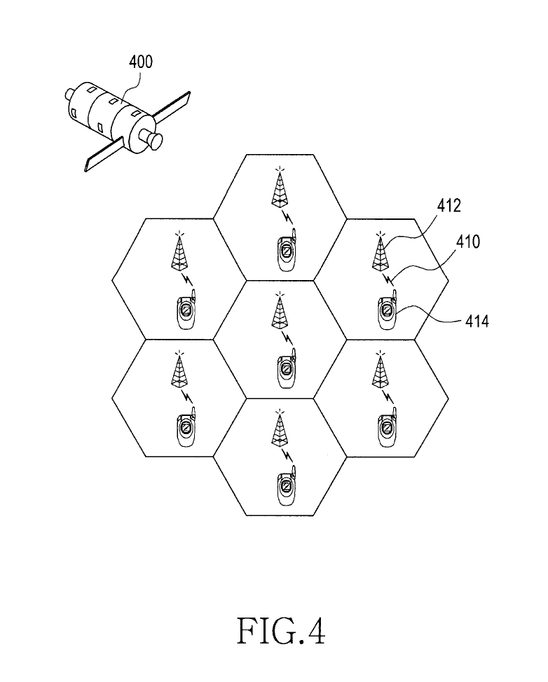

FIG. 4 is a view schematically illustrating the configuration of a wireless communication system to which the present invention is applied. As shown in FIG. 4, the wireless communication system includes a Global Positioning System (GPS) satellite 400 for identifying the location of at least one mobile terminal among a plurality of mobile terminals having location information modules and for acquiring desired location information, the plurality of mobile terminals, and a plurality of base stations in communication with the plurality of mobile terminals and provides the mobile terminals with services. A predetermined base station 412 in the wireless communication system transmits its own information to at least one mobile terminal 414, which is located within the coverage 410 of the predetermined base station 412, by periods in a unit of predetermined time, thereby providing a plurality of mobile terminals with a call service, a data service, etc.

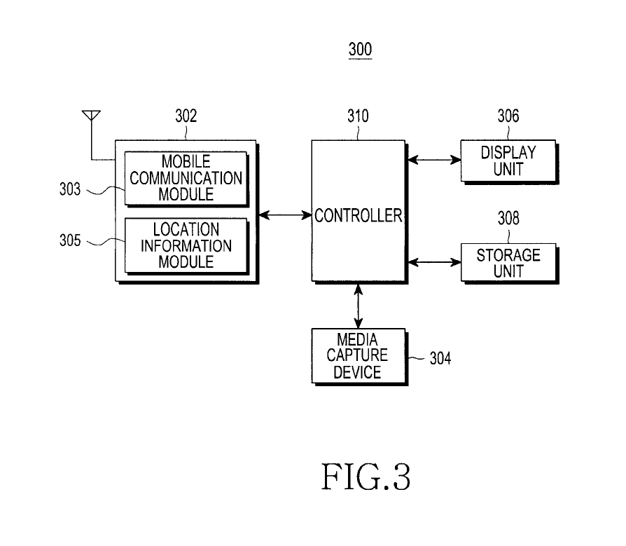

In the above description, an example of a screen when geo-tagging is performed, and a base station information acquisition process associated with the geo-tagging according to an exemplary embodiment of the present invention have been schematically explained. Hereinafter, an apparatus for power control when geo-tagging is performed in a mobile terminal according to an embodiment of the present invention will be described in detail with reference to FIG. 3.

FIG. 3 is a block diagram illustrating the configuration of an apparatus for power control when geo-tagging is performed in a mobile terminal according to an embodiment of the present invention. Referring to FIG. 3, the mobile terminal 300 includes a wireless communication unit 302, a camera 304, a display unit 306, a storage unit 308, and a controller 310. In addition, the mobile terminal 300 may further include a microphone, a speaker, an alarm unit, etc.

First, the wireless communication unit 302 includes one or more components for allowing radio communication between the mobile terminal 300 and a wireless communication system or radio communication between the mobile terminal 300 and a network in which the mobile terminal 300 is located. For example, the wireless communication unit 302 may include a mobile communication module 303 and a location information module 305.

The mobile communication module 303 transmits/receives radio signals to/from at least one among a base station, an external terminal, and a server in a mobile communication network. Here, the radio signals may include a voice call signal, a video call signal, and/or various types of data based on text/multimedia message transmission/reception.

Also, the location information module 305 is a module for identifying or acquiring a location of the mobile terminal 300. A representative example of the location information module 305 is a Global Positioning System (GPS) module.

The camera 304 processes image frames of still or moving pictures obtained by an image sensor in an image communication mode or a photographing mode according to the operation mode of the mobile terminal 300. In addition, the processed image frames may be displayed on the display unit 306 under the control of the controller 310.

The display unit 306 displays information processed in the mobile terminal 300. For example, when the mobile terminal 300 is in a phone call mode, the display unit 306 displays a user interface (UI) or a graphical user interface (GUI) associated with a call. When the mobile terminal 300 is in a video call mode or photographing mode, the display unit 306 displays a captured image and/or received image, or a UI or a GUI. When mobile terminal 300 is in a geo-tagging mode, the display unit 306 displays a still picture and/or moving picture on a map and/or corresponding attributes.

The storage unit 308 may store programs for the processing and control operations of the controller 310, and may perform a function of temporarily storing input/output data, for example, a phone book, a message, a still picture, a moving picture, etc. Also, the storage unit 308 stores specific information corresponding to still picture and/or moving picture data, which has been obtained through recording by the media capture device 304, as a still picture and/or moving picture file in the form of metadata, and also stores base station information periodically transmitted from a serving base station, which is connected with the mobile terminal 300, together with the specific information. The controller 310 controls the general operations of the mobile terminal 300. For example, the controller 310 can perform control and processing associated with voice communication, data communications, image communication, etc.

Also, when the camera 304 is driven, the controller 310 searches for whether serving base station information exists in a plurality of pieces of image metadata stored in the storage unit 308, and controls a location information module to be driven or not to be driven according to a result of the search, thereby performing a control operation such that geo-tagging is performed on recoded media.

In more detail, when the media capture device 304 is requested to be driven, the controller 310 searches a plurality of media metadata stored in the storage unit 308 for whether or not there is base station information periodically transmitted from a serving base station, which is currently connected with the mobile terminal 300. When there is no serving base station information as a result of the search, the controller 310 drives the location information module 305 of the wireless communication unit 302 while recording a subject through the camera 304. Then, the controller 310 stores location information on an area where the recording is performed, which has been obtained through the location information module 305, in metadata of a corresponding image, and performs a control operation such that the base station information is mapped to the metadata of the recorded media.

Also, when serving base station information exists in a plurality of pre-stored media metadata, the controller 310 controls the camera 304 to record a subject, and performs a control operation such that location information mapped to metadata including the serving base station information is stored in metadata of recorded media.

In addition, when serving base station information does not exist in a plurality of pieces of pre-stored media metadata, the controller 310 drives the location information module while recording a subject, and performs a control operation such that location information acquired through the location information module and the base station information are mapped to metadata of recorded media.

The operation of the controller 310 to search for whether or not serving base station information exists in a plurality of pre-stored media metadata is performed only when the user makes a request for geo-tagging on recorded media.

In the above description, the apparatus for power control when geo-tagging is performed in a mobile terminal according to an embodiment of the present invention has been explained.

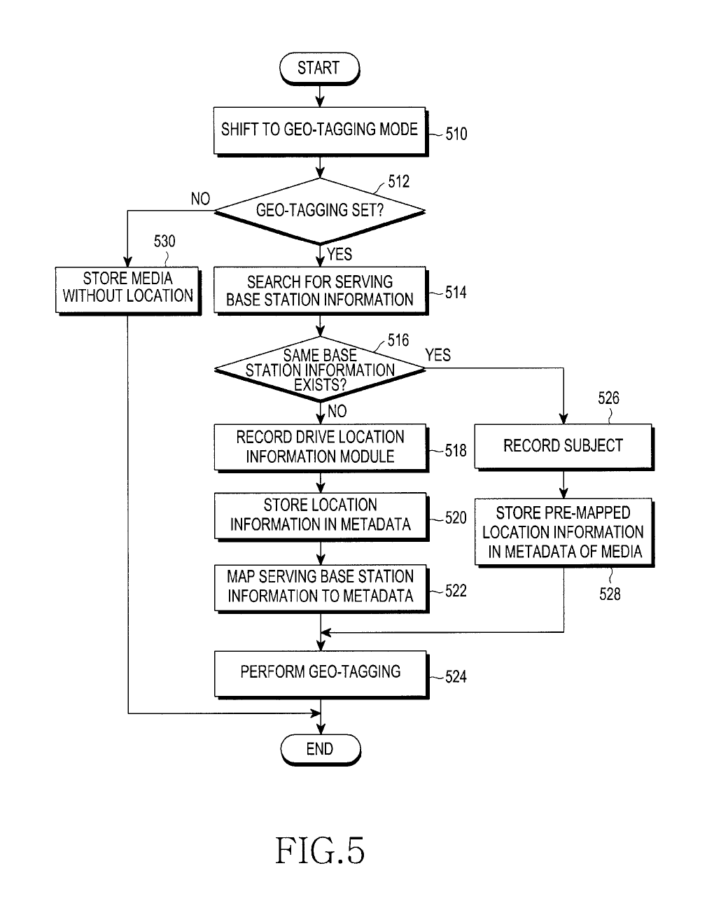

Hereinafter, a method for power control when geo-tagging is performed in a mobile terminal according to an embodiment of the present invention will be described in detail with reference to FIG. 5.

FIG. 5 is a flowchart illustrating a method for power control when geo-tagging is performed in a mobile terminal according to an embodiment of the present invention. Referring to FIG. 5, first, in step 510, the current mode of the mobile terminal is shifted to a geo-tagging mode.

In step 512, it is checked if geo-tagging is set in the shifted geo-tagging mode. In other words, when camera driving is requested by the user, it is checked if the performance of geo-tagging for acquiring location information of media to be recorded through the media capture device is desired, and the procedure proceeds to step 514 when the performance of geo-tagging on the corresponding media is desired as a result of the check. In contrast, when the performance of geo-tagging is not desired, the procedure proceeds to step 530, where recorded media data is stored without location information.

In step 514, a comparison and search operation is performed to determine if base station information periodically transmitted from a serving base station, which is currently connected with the mobile terminal, exists in a plurality of pre-stored image metadata. In this case, the image metadata means an exchangeable image file format (EXIF) tag, which includes the brand of the camera, a photographing time, exposure information, and a lens focal length.

In step 516, it is checked if information on the same base station as the serving base station exists as a result of the operation of step 514. When the serving base station information has been stored in at least one piece of metadata among the plurality of pre-stored media metadata as a result of step 516, the procedure proceeds to step 526, where a subject is recorded.

Then, in step 528, location information existing in metadata, in which the same base station information as the current serving base station information of the mobile terminal has been stored, is stored in metadata of a photographed image in step 526. Next, the procedure proceeds to step 524, where geo-tagging on the photographed media is performed.

Meanwhile, when the serving base station information does not exist in any metadata among the plurality of pre-stored media metadata as a result of the check in step 516, the procedure proceeds to step 518, where a subject is recorded through the camera, and simultaneously a location information module is driven. The location information module is driven to acquire latitude and longitude information of an area, at which the mobile terminal is currently located. In step 520, the location information acquired through the location information module is stored in media metadata obtained through the recording in step 518.

In step 522, base station information periodically transmitted from the serving base station, which is currently connected with the mobile terminal, is mapped to the metadata in which the location information has been stored in step 520. Accordingly, when geo-tagging is requested to be performed on media, which is recorded in the same base station area as the area corresponding to base station information stored in at least one piece of metadata, in the future, it is possible to search for whether or not serving base station information exists and to intactly read and utilize location information of image metadata including the searched base station information, without driving the location information module to acquire location information whenever the geo-tagging is performed. As a result, the waiting time required for the mobile terminal to drive the location information module and to acquire location information is reduced, so that it is possible to control the power of the mobile terminal when geo-tagging is performed.

The method and apparatus for power control when geo-tagging is performed in a mobile terminal according to an exemplary embodiment of the present invention can be achieved in the aforementioned manner. While the invention has been shown and described with reference to certain exemplary embodiments thereof, it will be understood by those skilled in the art that various changes in form and details may be made therein without departing from the spirit and scope of the invention as defined by the appended claims. Accordingly, the scope of the invention is not to be limited by the above exemplary embodiments but by the claims and the equivalents thereof

Note that the above-described methods according to the present invention can be realized in hardware or as software or computer code that can be stored in a recording medium such as a CD ROM, an RAM, a floppy disk, a hard disk, or a magneto-optical disk or downloaded over a network, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Having thus described an exemplary embodiment of a method for power control in a mobile environment, it should be apparent to those skilled in the art that certain advantages of the system have been achieved. According to the present invention, base station information of an area, which is not included in a photographing history, is stored. Thereafter, when it is determined that an area where an image is photographed is the area of the same base station as that corresponding to pre-stored base station information, location information stored together with the pre-stored base station information is utilized, without driving a location information module to acquire location information. Accordingly, it is unnecessary to drive the location information module to acquire location information every time whenever geo-tagging is performed, thereby reducing the waiting time for acquiring location information, so that it is possible to reduce the power consumption of the mobile terminal.

What is claimed is:

1. A method for power control in a mobile terminal, the method comprising:
searching for whether serving base station information periodically transmitted from a serving base station in communication with the mobile terminal exists in a plurality of pre-stored media metadata when a media capture device driving is requested;
recording a subject, and simultaneously driving a location information module when the serving base station information does not exist as a result of the searching; and
storing location information acquired through the location information module in metadata of a recorded media, and mapping the serving base station information to the metadata.

2. The method of claim 1, further comprising recording a subject through the media capture device when the serving base station information exists, and storing location information mapped to metadata including the serving base station information in the metadata of the recorded media.

3. The method of claim 1, further comprising geo-tagging the mapped location information and the serving base station information onto the recorded media.

4. The method of claim 1, wherein the searching for whether the serving base station information exists is performed when a geo-tagging request for the recorded media is made by a user.

5. The method of claim 1, wherein the serving base station information comprises:
a downlink center frequency of a base station, which is providing a service in an area where the mobile terminal is currently located; and
an identifier (ID) of the base station, and uplink/downlink channel information.

6. The method of claim 1, wherein the recorded media corresponds with a first media previously recorded for geo-tagging in an area in which a serving base station currently connected to the mobile terminal is located.

7. The method of claim 1, wherein the metadata corresponds to an exchangeable image file format (EXIF) tag, which comprises a brand of the camera, a photographing time, exposure information, and a lens focal length.

8. The method of claim 1, wherein the location information module is a global positioning satellite device.

9. An apparatus for power control in a mobile terminal comprising:
a media capture device;
a location information module for acquiring current location information; and
a controller for searching for whether serving base station information exists in a plurality of pre-stored media metadata when the media capture device is driven, controlling whether to drive the location information module according to a result of the search, and controlling performing of geo-tagging onto recorded media.

10. The apparatus of claim 9, wherein the controller performs a control operation to record a subject through the media capture device when the serving base station information exists in the plurality of pre-stored media metadata, and to store location information mapped to metadata including the serving base station information in metadata of the recorded media.

11. The apparatus of claim 9, wherein the controller performs a control operation to record a subject and to simultaneously drive the location information module when serving base station information does not exist in the plurality of pre-stored media metadata, and to map location information acquired through the location information module and the base station information to metadata of the recorded media.

12. The apparatus of claim 9, wherein the controller searches for whether the serving base station information exists in the plurality of pre-stored media metadata when a geo-tagging request for the recorded media is made by a user.

13. The apparatus of claim 9, wherein the metadata corresponds to an exchangeable image file format (EXIF) tag, which comprises a brand of the camera, a photographing time, exposure information, and a lens focal length.

14. The apparatus of claim 9, wherein the location information module is a global positioning satellite device.
